(19) United States
(12) Patent Application Publication
(10) Pub. No.: US 2019/0303811 A1
(43) Pub. Date: Oct. 3, 2019

(54) REDUCTION OF ENERGY CONSUMPTION OF A DEVICE BY AUTONOMOUS MONITORING OF CARGO TRANSPORT

(71) Applicant: LOGINNO LOGISTIC INNOVATION LTD, Shoham (IL)

(72) Inventors: Shachar Tal, Zichron Yaakov (IL); Amit Aflalo, Shoham (IL)

(21) Appl. No.: 16/365,743

(22) Filed: Mar. 27, 2019

Related U.S. Application Data
(60) Provisional application No. 62/649,586, filed on Mar. 29, 2018.

(51) Int. Cl. G06Q 10/04; G06Q 10/06; G06Q 50/06; G06Q 50/30; G06Q 10/08

(52) U.S. Cl. CPC G06Q 10/047; G06Q 10/06311; G06Q 10/083; G06Q 50/30; G06Q 50/06

(57) ABSTRACT

A device and a method are disclosed for reducing energy consumption by generating a Forecasted Geospatial Route and checking whether a cargo or vehicle is on-schedule and whether its environmental conditions are proper. The device receives standard shipping documents, from which Key Coordinates are extracted, from which a Forecasted Geospatial Route is generated. Subsequently, the device obtains real-time location data, time data and sensor data related to the coupled cargo or vehicle. The gathered data are then matched with location data, time data and sensory data stored within the device as the Forecasted Geospatial Route. The information match allows the device to check whether a cargo or vehicle is on-schedule or not and whether its environmental conditions are proper or improper. Subsequently, the device may turn all or several of its functions ON or OFF to reduce energy consumption.

### FIELD OF INVENTION

The present disclosure relates to reducing a monitoring device's energy consumption by managing and monitoring the transport schedule of a cargo or a vehicle, transported via land, air or sea, to which the apparatus is coupled.

### BACKGROUND

Cargo shipments are prone to delays, rescheduling, delivery to the wrong places and acts of malice such as theft. Furthermore, improper environmental conditions such as harmful temperature, shock, humidity, light and so on may damage many types of cargo. Therefore, it is important to monitor the movement and the environmental conditions of cargo, to make sure it arrives at its destination on time and intact. This may apply to cargo transported by land vehicles such as cars, trucks, buses and so on, or sea vehicles such as ships or air vehicles such as airplanes and helicopters.

With advances in technology, several techniques have been proposed to schedule and monitor timings and environmental conditions of the cargo moving from one point to another. One such technique includes providing an onboard device coupled to a central computer system placed remotely from the onboard device. The central computer system processes alerts transmitted by the onboard device and tracks the position of the onboard device. The onboard device includes a processor/sensor component and an antenna component. The processor/sensor component includes a processor for controlling the device and a memory. In one example, the onboard device can also include a global positioning system (GPS) receiver/antenna in communication with the processor for determining the position of the device.

It should be noted the above technique has several problems. For instance, the onboard device has to communicate with a central computer system to determine the position of the onboard device continuously. This requires a lot of energy and using batteries to power the onboard device may not be always feasible. Further, if the onboard device fails to communicate with the central computer system in the instances of bad weather or being in an enclosed shipping container (Faraday effect) or being in a bottom of a ship, or on a plane with no access to a network, etc. then the central computer has no information as to the whereabouts of the cargo.

### BRIEF SUMMARY

Device and a method are disclosed herein for generating a Forecasted Geospatial Route and managing the delivery times and environmental conditions of cargo by comparing real time information with the Forecasted Geospatial Route, using an object or a device that can be installed on the cargo, or on a vehicle to overcome the problems of the prior art.

It is one object of the present disclosure to provide a device to convert standard shipping documents into a Forecasted Geospatial Route. The device is configured to consider segments of said route to calculate/allocate a window of time during which the cargo will be deemed as adhering to its schedule.

It is another object of the present disclosure to selectively turn ON all or several functions of the device to obtain real time location of the cargo or the vehicle, or other sensory data such as intrusion, temperature, humidity, shock, vibration and so on. Further, real time location and sensory data is compared with the Forecasted Geospatial Route to determine whether the cargo or the vehicle are safe, in proper condition and adhering to their schedule.

It is one object of the present disclosure to turn OFF all or several functions of the device after comparing real time location with the Forecasted Geospatial Route.

Various methods are disclosed herein performed by a device installable on a cargo or vessel for monitoring the cargo or vessel during transport. The device includes a processor, memory, a position sensor. The methods include generating a planned route and a planned schedule for the cargo or the vehicle during the transport; storing the planned route and the planned schedule in the memory. During the transport, the position sensor is turned on and a real-time global location of the cargo or vehicle is obtained from the position sensor. The real-time global location is spatially compared with a corresponding global location derived from the stored planned route to produce a global displacement; and an actual time is temporally compared with a corresponding time derived from the stored planned schedule to produce a time lag.

Upon obtaining the real-time global location of the cargo or vehicle, the position sensor may be turned off. The device may further include a communications transceiver. Upon a magnitude of the global displacement being greater than a previously defined threshold, or upon the time lag being greater than a previously defined threshold time difference, the processor may enable communications (if and/or when communications are available) by turning on the communications transceiver.

The device may further include an environmental sensor be attached to the processor and memory storing forecasted sensory data. The processor may be further configured to during the transport to turn on the environmental sensor to receive an actual sensory datum pertaining to the environment of the cargo or the vehicle. The processor may compare the actual sensory datum to a corresponding datum selected from the forecasted sensory data. Upon the actual sensory datum differing from the corresponding forecasted datum greater than a previously defined threshold, then the processor may enable communications, to turn on the communications transceiver if and when communication is available.

The processor may be configured to determine if communications are available responsive to the real-time global location.

The device may further include a communications transceiver. The processor may be further configured to maintain the communications transceiver in a low power consumptive state (or power off state) when communications are not available.

### BRIEF DESCRIPTION OF FIGURES

In the following drawings like reference numbers are used to refer to like elements. Although the following figures depict various examples of the invention, the invention is not limited to the examples depicted in the figures.

FIG. 1 illustrates a general block diagram of device for providing real time information, which is then checked against a Forecasted Geospatial Route, to manage and monitor the schedule and environmental conditions of a vehicle or cargo, in accordance with one embodiment of the present disclosure;

FIG. 2 shows a cross-sectional detail of a housing including the device according to an embodiment of the present invention;

FIG. 3 shows a more detailed block diagram of the device, according to an embodiment of the present invention;

FIG. 4 illustrates a progress bar with points of interest along the Forecasted Geospatial Route, in accordance with an embodiment of the present disclosure; and

FIG. 5 illustrates the Forecasted Geospatial Route created, in accordance with an embodiment of the present disclosure.

### DETAILED DESCRIPTION

The following detailed description is intended to provide example implementations to one of ordinary skill in the art, and is not intended to limit the invention, as one of ordinary skill in the art will understand that variations can be substituted that are within the scope of the invention as described. Further, relational terms such as first and last, and the like, may be used to distinguish one entity from the other, without necessarily implying any actual relationship or order between such entities.

By way of introduction, the present disclosure relates to reducing energy consumption of an electronic device installed on a cargo or vehicle by turning off all or several functions of the device, which are not needed while the cargo or vehicle is on schedule and in proper environmental conditions. Determining whether or not a cargo or vehicle is on-schedule and its environmental conditions are proper, is done by matching real-time location data, time data and sensor data with a dataset known herein as a Forecasted Geospatial Route, which may be generated using information extracted from standard shipping documents.

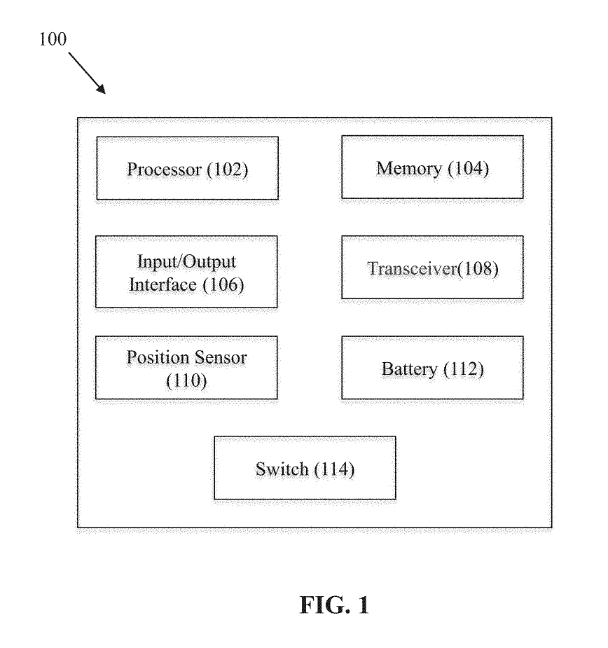

Referring to FIG. 1, the device 100 is disclosed for managing schedule of a cargo or a vehicle. The device 100 includes a processor 102, a memory 104, an Input/Output (I/O) interface 106, a transceiver 108, a position sensor 110, a battery 112, and a switch 114. The device 100 may be installed on the cargo or on a land vehicle such as a car, truck, bus and so on. In another example, the device 100 may be installed in a ship, shipping container and so on. In another example, the device 100 may be installed on a flying platform, or cargo traveling on a flying platform. In another example, the device 100 may be coupled to an object or an asset.

Another important benefit of the present invention relates to real time alerts. A sensor connected to the device 100 may detect a condition which may require immediate reporting. A high temperature in a shipping container may indicate a fire or cooling system failure requiring immediate attention. If the mobile network transceiver is powered down in order to conserve battery power then several minutes would be required using prior art systems/methods to acquire a network even if a network is available. One of the intentions of the present invention in certain embodiments is to reduce the time (to seconds) between sensing an alert condition and transmitting an alert without having the transceiver(s) always powered.

While the disclosure as follows includes a detailed description of a device 100 according to an embodiment of the present invention installed on a shipping container as an example of a movable asset being tracked/secured/monitored, the invention as claimed may be applied equally to other types of movable assets. For example, a device 100 according to different embodiments of the present invention may be installed on or inside a shipping crate pallet to track/secure the shipping crate. According to a different embodiment of the present invention, a device 100 may be attached to the closure of a shipping or postal bag to track and/or secure the postal bag.

In a different embodiment, the present invention may be applied to mobile computer systems such as smart-phones, portable and/or mobile computers such as laptop computers, net-book computers and/or tablets which are enabled to communicate over a wireless wide area network. Application of the present invention will result in a considerable reduction in time to acquire a network in addition to saving battery power.

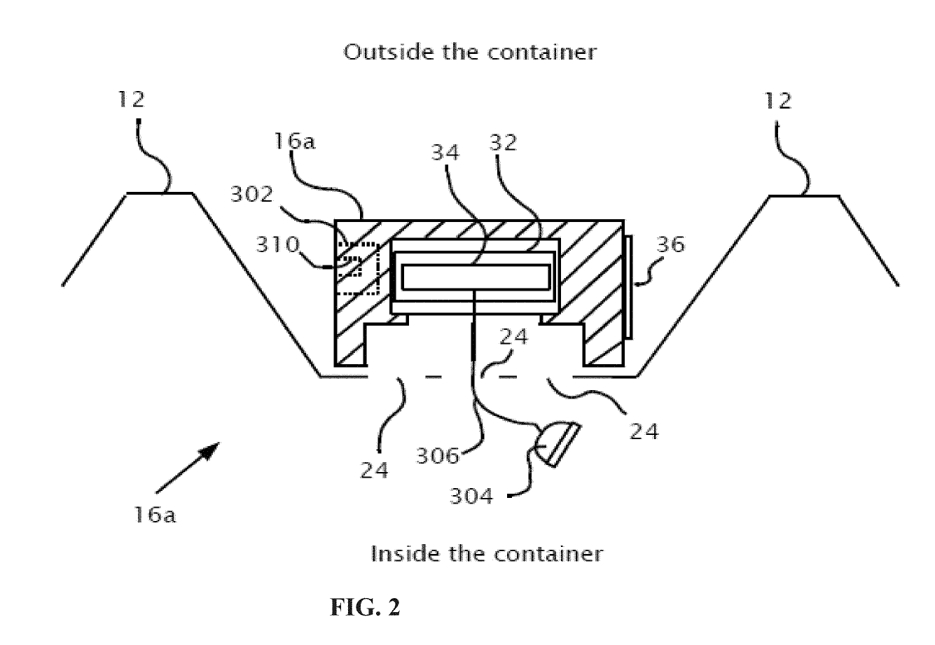

Reference is now made to FIG. 2 which shows a cross-sectional detail of a housing 16a including a device 100 according to an embodiment of the present invention. Housing 16a is shown attached to flat surface of wall 12 between corrugated sections of wall 12 and mounted on the outside of a shipping container (not shown). A sensor 304, e.g. passive infra-red PIR sensor, is located on the inside of container and is attached to circuit board 34 with cable 306. Cable 306 connects board 34 to sensor 304 through ventilation hole 24. Multiple ventilation holes 24 may allow for multiple sensors, transducers or antennas to be located inside container which may be connected to circuit board 34. Multiple sensors, transducers or antennas may be located inside container typically may allow for sensing of temperature, humidity, pressure, air quality, motion, along with the removal and placement of objects inside container.

Antenna 36 is connected to circuit board 34 and may be disposed on the inside of housing 16a (along with board 34 and battery holder 32) if housing 16a is made from an electrically non-conductive material. If housing 16a is made from electrically conductive material such as metal, antenna 36 may be mounted outside the exterior surface of housing 16a. Antenna 36 is typically located and oriented to allow for either vertical and/or horizontal polarization. Antenna 36 is shown externally on a vertical face of housing 36 by way of example only. One or more antennas 36 may be placed on other external faces of housing 16a, disposed internally within housing 16a and/or as part of circuit board 34.

Circuit board 34, battery holder 32 and/or batteries (not shown) may be cast inside of housing 16a as part of the manufacturing process, e.g. injection molding, of housing 16a. The manufacturing process, may include use of either thermoplastic or thermoset, e.g. epoxy, urethane materials. Alternatively, battery holder 32 and/or circuit board 34 may be mounted inside of housing 16a using conventional attachment means known in the art subsequent to injection molding.

A mutual inductive coupling 302, on the inside of housing 16a, may be used for charging re-chargeable batteries. Coupling 302 may have an aperture 310 which provides a mutual inductive coupling to a secondary magnetic core. Mutual inductive coupling 302 has a secondary winding which is wound around the secondary magnetic core. The secondary winding provides a low voltage alternating current (AC) output when a primary magnetic core (with a primary winding connected to mains electricity) is inserted into the aperture 310 of coupling 302. The low voltage AC output of the secondary winding is rectified to provide a direct current (DC) used for charging batteries in battery holder 32 when batteries are re-chargeable. Batteries in battery holder 32 may need to be re-charged or replaced prior to the shipping and delivery of a container. When the batteries in battery holder 32 are replaced, typically when container is being reloaded, housing 16a is removed from the side of container by unfastening fasteners (not shown), the batteries in battery holder 32 are replaced and housing 16a is re-attached to container using fasteners. Alternatively, batteries may be recharged using kinetic charging, inductive charging, RF charging, solar and/or wind power from an external power generation device, e.g. solar panel, wind turbine.

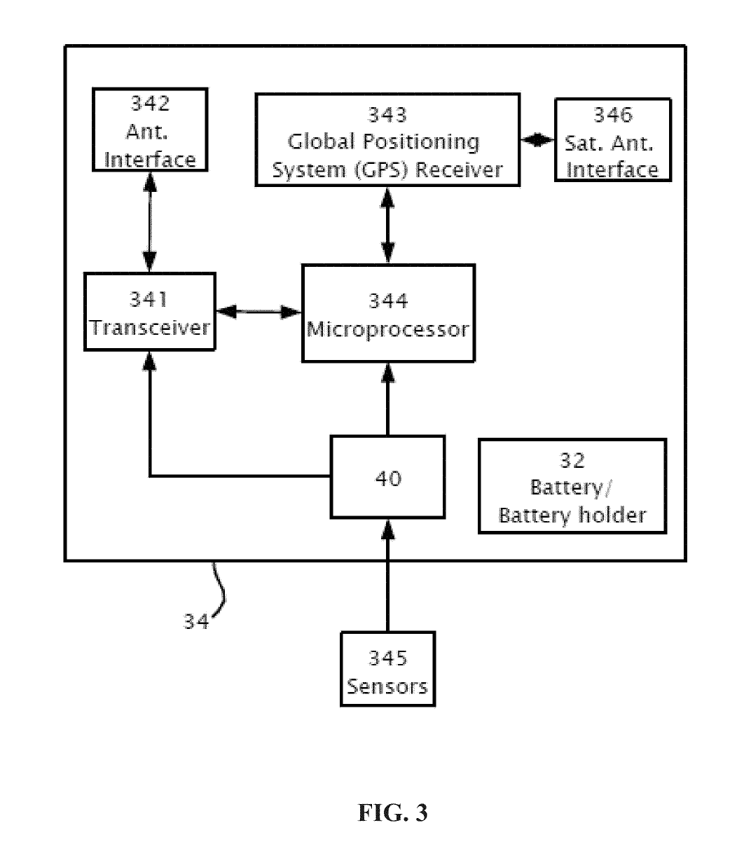

Reference is now also made to FIG. 3 which shows a more detailed block diagram of the device 100 or that shows further details of circuit board 34 according to an embodiment of the present invention. Circuit board 34 is powered by batteries placed in battery holder 32. Circuit board 34 includes an antenna interface 342 which allows one or multiple antennas 36 to be connected to one or more transmitters, receivers and/or transceivers 341. A single transceiver 341 and a single antenna interface 342 is shown, by way of example. Transceiver 341 may be one of multiple transceivers (not shown) Transceiver 341 may be a satellite transceiver, or another transceiver operating with another wireless wide area network.

An example of transceiver 341 is implemented in a single-chip such as GE864-QUAD V2 Telit range of products of Telit Wireless Solutions (Global Headquarters Telit Communications PLC—7th Floor, 90 High Holborn, London WC1V 6XX, UK).

Optionally, a satellite receiver 343 for global positioning system (GPS) may be attached to a port 346 for a satellite antenna externally mounted in or outside housing 16a. Both satellite receiver 343 and transceiver 341 are operatively connected to a processor 344 (with memory built in and/or attached thereto). A circuit 40 is connected between processor 344 and sensor interface 345. An output of circuit 40 may connect to transceiver 341. Sensor interface 345 allows data to be sent and received from one or multiple sensors 304 (as shown in FIG. 2) located inside container. The data are typically processed by processor 344 and/or a processor of circuit 40. Interface 345 typically may provide the function of sample and hold and appropriate analogue to digital (A/D) and digital to analogue (D/A) conversion of data sent and received between processor 344 and one or more sensors located inside container and/or on circuit board 34. Sensors may be passive infrared (PIR) sensor, a thermometer, an accelerometer sensor, proximity/intrusion detector and a microphone.

Referring back to FIG. 1, the processor 102 may be implemented as one or more microprocessors, microcomputers, microcontrollers, digital signal processors, central processing units, state machines, logic circuitries, and/or any devices that manipulate signals based on operational instructions. Among other capabilities, the processor 102 is configured to fetch and execute computer-readable instructions stored in the memory 104. The memory 104 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes.

The I/O interface 106 may include a variety of software and hardware interfaces, for example, a web interface, a graphical user interface, and the like. The I/O interface 106 may allow the device 100 to interact with a user directly. Further, the I/O interface 106 may enable the device 100 to communicate with other computing devices. The I/O interface 106 may facilitate multiple communications within a wide variety of networks and protocol types, including wired networks, for example, LAN, cable, etc., and wireless networks, such as WLAN, cellular, or satellite. The I/O interface 106 may include one or more ports for connecting a number of devices to one another or to another server. The transceiver 108 is used to send or receive communications with other devices and/or the server.

The position sensor 110 may include variety of sensors such as a Global Positioning System (GPS) sensor, GLONASS or “Global Navigation Satellite System” and so on.

The battery 112 may include a rechargeable battery such as a lithium-ion battery known in the art or a non-rechargeable battery.

The switch 114 may indicate a power switch such as a load switch or power relay or switching function feature of a component within the device 100 that can be used by the user to turn ON or turn OFF all or several functions of the device 100.

The present disclosure is explained considering that the device 100 is coupled to a cargo. The cargo may be transported using a land vehicle, sea vehicle such as a ship, air vehicle such as airplane or drone, or combination thereof. In one implementation, the device 100 may be configured to receive a set of coordinates and times, hereinunder: the “Forecasted Geospatial Route”. This Forecasted Geospatial Route may include coordinates of a point-of-origin, a plurality of intermediary coordinates and a point-of-destination. The point-of-origin may indicate coordinates of a location from which the cargo's voyage is forecasted to start. The point-of-destination may indicate coordinates of a location from which the cargo's voyage is forecasted to end. As such, between the point-of-origin and the point-of-destination there may exist a plurality of intermediary locations indicating mid points-of-interest that exist along the Forecasted Geospatial Route between the point-of-origin and the point-of-destination.

In one embodiment of the disclosure, the device 100 may receive a select number of Key Coordinates, together with the forecasted times and dates for the point-of-origin, point-of-destination, and key points-of-interest in between, the device 100 converts the coordinates into a Forecasted Geospatial Route.

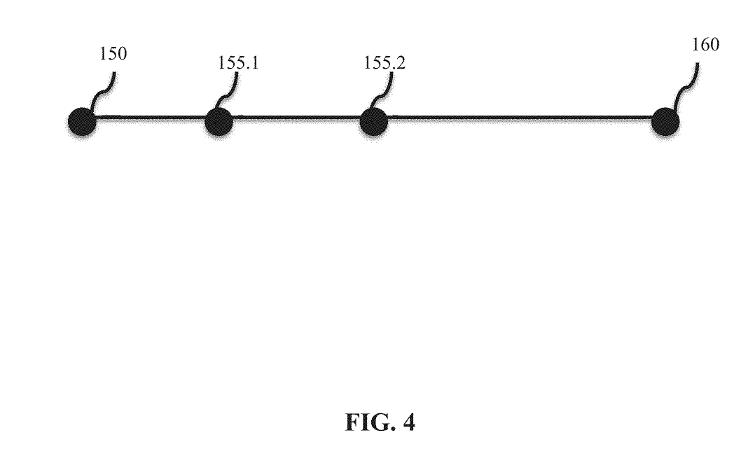

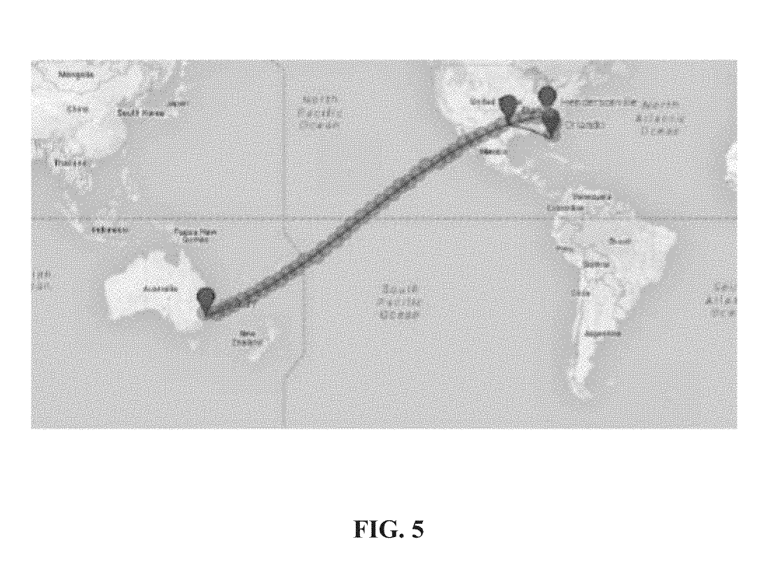

Referring to FIG. 4, a point-of-origin (for example: the exporter's warehouse) 150, a plurality of intermediary points-of-interest 155.1 (port of loading), 155.2 (port of discharge) and a point-of-destination (import warehouse) 160, are shown in FIG. 4 as circular shapes along a straight line, whereas the length of the line indicates time. In the current implementation, the device 100 is configured to receive a Forecasted Geospatial Route, which is shown in FIG. 5.

In one embodiment of the disclosure, the Key Coordinates and Times are retrieved from standard shipping documents. These documents, which contain all the information from which the Forecasted Geospatial Route may be calculated, may include but not limited to a bill of lading, house bill of lading, master bill of lading, transshipment bill of lading, booking confirmation and so on. The device 100 analyzes the Key Coordinates and Times along the voyage, each noted in the shipping documents, and uses an internal or external table or API service to form a complete route from the point-of-origin 150 to the point-of-destination 160. For example, consider that the cargo needs to be sent from a point-of-origin address (e.g., export warehouse) 150, and delivered to a point-of-destination address (e.g., import warehouse) 160, according to the shipping documents. Along the way, according to the shipping documents, the cargo may be loaded at a port of loading 155.1 and may be unloaded and further transported at a port of discharge 155.2. In the current example, the port of loading 155.1 and the port of discharge 155.2 may indicate the intermediary points as shown in FIG. 4. Furthermore, dates and times for loading and discharge are also obtained from the shipping documents. In the above example, the shipping documents may note that the cargo may be sent using a land vehicle from the export warehouse 150 to port of loading 155.1. Further, the shipping documents may note that the cargo may be transported in a ship from the port of loading 155.1 to the port of discharge 155.2. Furthermore, the shipping documents may note that the cargo may be transported using another land vehicle from the port of discharge 155.2 to the import warehouse 160.

In one example, the device 100 receives Key Coordinates and Times, or shipping documents from which Key Coordinates and Times may be extracted as above, and uses an internal or external table or API service or other external sources to form a complete route from the point-of-origin to the point-of-destination, i.e. the Forecasted Geospatial Route. For instance, truck routes from the point-of-origin to the port of loading, or from the port of discharge to the point-of-destination, are calculated based on map provider's routing API e.g., Google routing API, Bing routing API etc. Further, train routes may be calculated based on train schedules from a train central database. Further, ship routes are taken from historical data of ship lines or similar marine databases such as AIS and so on. Furthermore, planes routes are taken from historical data of plane lines or similar aviation databases such as ACARS, ADS-B and so on.

After the abovementioned routing process, a path connecting all the points-of-interest is known. Based on the type of transportation such as truck, train, or ship, geospatial tolerances are then created to form shapes of different sizes along the path. For example, a circle of 5 km radius along a path of a train, 10 km radius along a path of a truck, 100 km radius along a path of a ship etc.

Further, ingress and egress times are calculated based on estimated time of arrival and estimate time of departure for each shape along the route.

Following is a calculation of ingress (entrance) times and egress (exit) times for circular shapes along a Forecasted Geospatial Route at sea between two ports:

(DistancePortA−PortB/50)=#N of GFs=GF0,GF1 . . . GFn

Ingress time GF0=ETDPortA

Ingress time GF1=ETDPortA+[1/N*(ETAPortB−ETDPortA)]

Ingress time GF2=ETDPortA+[2/N*(ETAPortB−ETDPortA)]

Ingress time GFn=ETDPortA+[n/N*(ETAPortB−ETDPortA)]

Ingress time GFN=ETDPortA+[N/N*(ETAPortB−ETDPortA)]=ETAPortB

Egress time should be relative to ingress time by a factor of X to add to n so:

Egress time GF0=ETDPortA+[(X+0)/n*(ETAPortB−ETDPortA)]

Egress time GF1=ETDPortA+[(X+1)/n*(ETAPortB−ETDPortA)]

Egress time GF2=ETDPortA+[(X+2)/n*(ETAPortB−ETDPortA)]

Egress time GFn=ETDPortA+[(X+n)/n*(ETAPortB−ETDPortA)]

TABLE 1
Table 1: Geofence

| Event | Logic | Action |
|---|---|---|
| Ship is on | Ship is at | Ship is off-schedule. Low priority. If POD ETA is updated- |
| course but | allowed GF | it should be updated in the dashboard too and switched |
| late | but after | to middle priority |
| | egress time | |
| Minor sway | Ship not at | 1. Calculate remaining distance to see if reachingnext |
| from course or | allowed | port on time is feasible (same distance as scheduled GF from next port) |
| port skip | schedule | 2. Monitor POD ETA change |
| (non-POL/POD). | (GF/time) | If any is TRUE -Shipis off-schedule. Middle priority. alert and |
| Ship will arrive | | change POD ETA accordingly |
| more or less at | | |
| ETA to POD | | |
| Port skip | Shipdoes not enter | Shipis off-schedule. High priority. Issue tasks. |
| at POL/POD | POL or POD GF | |
| Container | ANY shock detection | Ship is off-schedule. High priority. Issue tasks. |
| offloaded at | resulting from NON | Need to create “ship perimeter” of 50 km |
| wrong port | POL/POD port | radius to be compared to such container location reports |
| | OR | |
| | Any location report | |
| | of container | |
| | OUTSIDE | |
| | “ship perimeter” | |

In an embodiment of the Forecasted Geospatial Route, the shapes align with the routing line such that there is enough congruency between each shape to allow for a coherent snake-like area, consisting of smaller circular areas. The above process may be executed for as many adjacent coordinates in the route as needed. For example, 10 adjacent coordinates between the export warehouse to point of loading (100 km path, via truck, coordinates are 10 km apart), 13 adjacent coordinates between the port of loading and the port of discharge (1300 km path, via ship, coordinates are 100 km apart) and 30 adjacent coordinates between the port of discharge and the import warehouse (300 km path, via truck, coordinates are 10 km apart).

After creating the shapes, windows of time are matched with each shape. Specifically, the estimated time of departure and the estimated time of arrival of each two subsequent Key Coordinate (from the shipping documents) is considered and divided by the number of shapes in between those two subsequent Key Coordinates. Tolerance of +/−x shapes (for example +/−2 shapes) is given for each allowed window of time. After the abovementioned process, the shapes are presented along the route in a long snake-like shape with its specific time window as shown in FIG. 3. The data associated with the routes, shapes and times consisting of the Forecasted Geospatial Route is stored in the memory 104.

In one embodiment of the disclosure, sensory data related to cargo environmental conditions may be attached to each shape in the Forecasted Geospatial Route, for example: a range of temperatures, a range of humidity level, a maximum level of sock or vibration, a state of an intrusion detection sensor, battery charge levels and so on. The sensory data may be general, such as a general disallowance of intrusion anywhere but the import warehouse or the expert warehouse. The sensory data may also be cargo-specific, such as a range of temperatures which are needed to be kept for the proper transportation of chocolate, or frozen tuna. Such sensory data may be pre-configured, or determined from information extracted from the shipping documents in the same way as the Key Coordinates and time data is extracted. For example, if the shipping documents indicate that the cargo transported is chocolate, then the allowed range of the temperature sensor for all shapes, start to finish, or the Forecasted Geospatial Route, would be 12 to 18 degrees Celsius. During the voyage, if ever the temperature sensor of the device measure temperatures that are outside the aforementioned range, the environmental conditions for the cargo will be deemed improper.

In an embodiment of the disclosure, an external server is used to perform the abovementioned process, turning one or more shipping documents related to a specific shipment into a Forecasted Geospatial Route, consisting of shapes, times and sensory data. The external server then transmits the Forecasted Geospatial Route data to the device 100, which in turn stores it in the memory 104.

In operation, the device 100, or any of its functions, may be selectively turned ON i.e., the position sensor 110 may be turned ON to obtain real time location of the device 100. After obtaining the real-time location, the coordinates, the current times and the sensory data are compared with the Forecasted Geospatial Route information stored in the memory 104. If the real time location of the device 100 together with the current time match with the Forecasted Geospatial Route information stored in the memory 104, then the cargo in which the device 100 is coupled is considered to be on schedule. Similarly, if the real time location and the current time do not match with the information stored in the memory 104 for a particular route, then the cargo to which the device 100 is coupled is considered to be off schedule. It should be understood that the device 100 might also be coupled to vehicles or any other objects to ascertain their adherence to the schedule.

Similarly, the device 100, or any of its functions, may be selectively turned ON or OFF based on the comparison of real time sensory data, and the sensory data in the memory 104, which may be a part of the Forecasted Geospatial Route data. For example: a big shock sensed by the 3D accelerometer, may be compared to the Forecasted Geospatial Route. If the comparison indicates that such shock occurs at the port of loading, it may be attributed to a crane picking up the cargo, loading it onto a ship. In such case, the device 100 may want to turn OFF all or several of its functions, to conserve energy, as no intervention is necessary. On the other hand, if the comparison indicates that such shock occurs at the road between the port of discharge and the import warehouse, it may be attributed to an accident or unauthorized lifting. In such case, the device 100 may want to turn ON all or several of its functions, and report the event, as intervention is likely to be necessary. Additionally, such comparisons of real time temperature data, real time humidity data, real time intrusion detection data, real time battery level data, real time vibration data, real time acoustics data and so on may be performed in a similar fashion. In such cases, the comparison of the real time data to the data which exists in the memory 104, and may serve as part of the Forecasted Geospatial Route, may enable the device 100 to turn ON or OFF all or several of its functions, as some cases will require reporting or other functions to be executed, and in some cases, such would not be required.

In the current embodiment, the device 100 is configured to selectively turn ON and turn OFF all or several of its functions. The device 100 may turn ON or turn OFF all or several of its functions using the switch 114 as shown in FIG. 1. In other example, the device 100 is configured to turn ON all or several of its functions, including the function which compares real time data to the Forecasted Geospatial Route, at pre-defined time intervals, for example an interval of 10 minutes, 30 minutes and so on in order to function without user intervention. Further, the device 100 is configured to turn OFF after a predetermined time e.g., 5 seconds or 10 seconds. For example, the device 100 is configured to turn ON at intervals of 10 minutes say at LOAM, 10.10 AM, 10.20 AM and so on. After turning ON, the device 100 stays ON for 10 seconds and turns OFF. The device 100 is configured to turn ON or turn OFF all or several of its functions with or without user intervention. It is to be understood that the device 100 is used to check whether the cargo (with which the device is coupled) is adhering to the forecasted schedule or the path defined/stored, and is in proper environmental conditions as indicated by the sensor data part of the Forecasted Geospatial Route at any given time.

After matching real time location, current time and real time sensor data with the Forecasted Geospatial Route, if the real time location, current time and real time sensor data match with the allowed data ranges stored in the memory 104 as the Forecasted Geospatial Route, then device 100 may be configured to turn OFF all or several of its functions in order to save battery 112. The device 100 may also save a state in the memory 104, indicating that the cargo is on-schedule and its environmental conditions are proper.

Further, if the real time location, current time and real time sensor data do not match with the allowed data ranges stored in the memory 104 as the Forecasted Geospatial Route, then the device 100 may be configured to turn ON all or several of its functions in order to perform relevant tasks, such as to send a signal/notification to the user, indicating that the cargo is not on schedule, and/or is transported under improper environmental conditions.

Functions which can be turned ON or OFF based on matching real time location, current time and real time sensor data with data stored in the memory 104 as the Forecasted Geospatial Route, may include: turning on or off a communications modem (cellular, satellite, Wi-Fi, Bluetooth, LAN modems and WAN modems and so on), turning on or off a sensor (accelerometer, temperature, intrusion detection, light, sound, vibration, and so on), setting or changing a threshold for a sensor, temporary disconnection of an energy source, temporary start or stoppage of an energy generation mechanism (solar, kinetic, electromagnetic and so on), configuring components to enter or exit hibernation and/or low consumption modes and so on.

As the current disclosure compares real time information against information stored in the memory 104, the device 100 does not have a need to communicate with a server (not shown), or have access to an external network (not shown) to check whether the cargo is on-schedule and whether its environmental conditions are proper. The device 100 may turn ON at will, perform the comparison of real time information against information stored in the memory 104, and then turn all or several of its functions OFF. As the device 100 is not ON at all times, power consumption by the device 100 may be saved leading to lower dependency on energy resources to power the device. Further, the device 100 may function independently without need of communicating constantly with a server, as is the case today with most location-based application. As a result, the device 100 may use a battery only when it is turned ON, without the need to connect to external power sources. Further, the device 100 may use a battery when it is required to communicate with the server. Further, the device 100 may be coupled as an add-on device to the cargo or the vehicle to determine their schedule, and location at any given time. It should also be noted that the device 100 may be coupled to a cargo irrespective of the transportation mode i.e., land, sea or air transportation.

Although embodiments of the device and the autonomous monitoring and energy saving mechanism have been described in language specific to features and/or methods, it is to be understood that the description is not necessarily limited to the specific features or methods described. Rather, the specific features and methods are disclosed as examples of implementations of a device and mechanism for autonomous monitoring and energy saving.

It should be noted that the terms “forecasted geospatial route” and “planned route” are used herein interchangeably.

The terms “position” and “location” are used herein referring to locations on or relative to the Earth, are used herein interchangeably.

The term “actual” in the context of “actual time” as used herein may refer to a real time clock, e.g. date and time, or may refer to a relative time, such as relative to time of embarkation.

The term “lag” as used herein refers to a time delay relative to the planned or forecasted schedule. A negative value for “lag” means that the vehicle or cargo reached a point on the route ahead of schedule.

What is claimed is:

1. A method performed by a device installable on a cargo or vessel for monitoring the cargo or vessel during transport, the device including a processor, memory, a position sensor, the method comprising:
generating a planned route and a planned schedule for the cargo or the vehicle during the transport;
storing the planned route and the planned schedule in the memory;
during the transport:
turning on the position sensor;
obtaining from the position sensor, real-time global location of the cargo or vehicle;
spatial comparing the real-time global location with a corresponding global location derived from the stored planned route to produce a global displacement; and
temporal comparing an actual time to a corresponding time derived from the stored planned schedule to produce a time lag.

2. The method of claim 1, further comprising:
upon said obtaining from the position sensor, the real-time global location of the cargo or vehicle, turning off the position sensor.

3. The method of claim 1, wherein the device further includes a communications transceiver, further comprising:
upon magnitude of the global displacement being greater than a previously defined threshold, or
upon time lag being greater than a previously defined threshold time difference,
enabling communications, by the processor, to turn on the communications transceiver if and when communication is available.

4. The method of claim 1, further comprising:
determining if communications are available responsive to the real-time global location.

5. The method of claim 1, wherein the device further comprises a communications transceiver, the method further comprising:
maintaining the communications transceiver in a low power consumptive state when communications are not available.

6. The method of claim 1, wherein the device further includes an environmental sensor attached to processor, the method further comprising:
storing forecasted sensory data; and
during the transport:
turning on the environmental sensor thereby receiving an actual sensory datum pertaining to the environment of the cargo or the vehicle;
comparing the actual sensory datum to a corresponding datum selected from the forecasted sensory data;
upon the actual sensory datum differing from the corresponding forecasted datum greater than a previously defined threshold, then enabling communications by the processor, to turn on the communications transceiver if and when communication is available

7. A device installable on a cargo or vessel for monitoring the cargo or vessel during transport, the device including a processor, memory, a position sensor, wherein a planned route and a planned schedule for the cargo or the vehicle during the transport are stored in the memory, the processor, during the transport, is configured to:
turn on the position sensor;
obtain from the position sensor, real-time global location of the cargo or vehicle;
spatially compare the real-time global location with a corresponding global location derived from the stored planned route to produce a global displacement; and
temporally compare an actual time to a corresponding time derived from the stored planned schedule to produce a time lag.

8. The device of claim 7, wherein the processor is further configured to:
turn off the position sensor upon obtaining from the position sensor, the real-time global location of the cargo or vehicle.

9. The device of claim 7, further including: a communications transceiver, wherein the processor is further configured to enable turning on the communications transceiver when communications are available and when either: a magnitude of the global displacement is greater than a previously defined threshold, or upon the time lag is greater than a previously defined threshold time difference.

10. The device of claim 7, further comprising:
an environmental sensor attached to processor;
memory storing forecasted sensory data; and
wherein the processor is further configured to during the transport:
turn on the environmental sensor thereby receive an actual sensory datum pertaining to the environment of the cargo or the vehicle;
compare the actual sensory datum to a corresponding datum selected from the forecasted sensory data;
upon the actual sensory datum differing from the corresponding forecasted datum greater than a previously defined threshold, then enable communications by the processor, to turn on the communications transceiver if and when communication is available.

11. The device of claim 7, wherein the processor is configured to determine if communications are available responsive to the real-time global location.

12. The device of claim 7 further comprising a communications transceiver, wherein the processor is further configured to maintain the communications transceiver in a low power consumptive state when communications are not available.
